(19) United States
(12) Patent Application Publication
(10) Pub. No.: US 2001/0055948 A1
(43) Pub. Date: Dec. 27, 2001

(54) Broadcasting receiving apparatus

(75) Inventors: Masaaki Ikeda, Kitamoto City (JP); Noriaki Sato, Ichikawa City (JP); Toshihisa Nakamura, Matsudo City (JP)

Correspondence Address: OLIFF & BERRIDGE, PLC, P.O. BOX 19928, ALEXANDRIA, VA, 22320, US

(73) Assignee: TDK CORPORATION

(21) Appl. No.: 09/828,155

(22) Filed: Apr. 9, 2001

(30) Foreign Application Priority Data
Oct. 15, 1999 (JP) 11-294116

(51) Int. Cl. H04B 7/185

(52) U.S. Cl. 455/13.3; 455/13.1; 455/98; 455/82

(57) ABSTRACT

Receiving apparatus for receiving satellite broadcasting electric wave to be mounted mobile vehicle being realized at low cost and not influence by the weather etc. The apparatus is provided with an antenna of which directivity pattern can be varied, and by a geomagnetism sensor mechanically coupled with said antenna to detect present orientation of the antenna, and comprising antenna controlling means by which the directivity pattern of the antenna is directed towards objective broadcasting satellite based on said detected orientation output. When an electric wave from a gap-filler station is to be received, the antenna is controlled to become non-directivity pattern automatically. For the antenna, a microstrip patch antenna having a plurality of conductive patches arranged in a plane is used.

### BACKGROUND OF THE INVENTION

1. Field of the Invention

The present invention generally relates to a signal receiving apparatus mainly mounted on a mobile vehicle but may include a stationary or mobile receiving site from a signal sent from a satellite and from a ground transmitter station. More especially, the invention relates to a signal receiving apparatus able to optimize the receiving signal intensity by varying the directivity of the antenna according to the receiving location and the receiving conditions so as to receive a stabilized signal even if the receiving conditions vary.

2. Prior Art Description

Presently planned S-band mobile multimedia satellite broadcasting system is to use a stationary communication satellite with S-band frequencies i.e. 2.6 GHz band to transmit information contents relating to data or text, voice and moving pictures etc. to a mobile apparatus. The system is to realize a communication link without the need to track the satellite wave by using a parabolic antenna but is able to receive the radio wave by a small antenna mounted on a mobile vehicle.

In the case of the digital satellite broadcasting for mobile stations, the electric wave from the satellite may be interrupted when the mobile station is passing through a tunnel, valley or in a road along a sharply inclined area or located between high buildings. So that for such locations a gap-filler ground facility may previously be installed and such a gap-filler station retransmits the broadcasting electric wave received from the satellite. The carrier wave of the broadcasting wave from the satellite or such a gap-filler station to the mobile stations may be modulated by QPSK/BPSK (quadrature phase shift keying/binary phase shift keying).

For receiving such a broadcasting wave from a satellite efficiently, the receiving antenna is controlled so its directivity pattern always directed towards the satellite (for instance due south in the horizontal plane) by obtaining relative positional data between the satellite and the mobile station. In the prior art technique, the exact location of the receiving station is detected by using a GPS system and by comparing it with previously stored data between the location of the satellite and that of the ground station and to receive an antenna having an optimum directivity function. Such technique had been disclosed in Japanese Patent Opened Publication No. 216794/1994, Japanese Patent Opened Publication No. 17433/1999 and Technical Report of IECE A-P97-81 (1997-08) Tsuji, Matsuzawa and Ito, etc.

In case of such a prior system, if the GPS receiving is not available, an optimum control is not possible. Such a system is higher cost. Also, a control based on a phased array principle in order to avoid appearance of multipath signals as far as possible, the number of the antenna elements should be increased for attaining an optimum control. In this case, a system depending on GPS may achieve an ideally detailed beam control of the antenna reception. However, when considering public applications, the system itself becomes complicated and hence high cost. Also the GPS signal tends to be influenced by the weather and location so that in some instances the receiving becomes not possible.

### SUMMARY OF THE INVENTION

The present invention is related to a receiving apparatus comprising an antenna of which its directivity pattern can be varied according to the beam direction and the shape of the beam respectively, a tuner receiving the electric wave signal from the antenna, a control unit for controlling the directivity pattern of the antenna and a geomagnetism sensor for obtaining physical orientation signal of the antenna. The orientation signal obtained from the geomagnetism sensor is fed to the control unit. The control unit refers the orientation signal with previously stored data related to the direction of the satellite to be received and decides on the direction of the beam pattern of the antenna to be directed and its beam pattern according to an algorithm previously stored in ROM or RAM.

According to the present invention, by controlling the directivity pattern of the antenna, detecting the received level of the electric wave and by the orientation signal obtained by the geomagnetism signal, an interruption of the receiving signal can be avoided even if rotating the direction of the receiving apparatus.

Also in the system of the present invention, even at a time when the detection of the direction by the geomagnetism sensor is unobtainable due to a disturbance by an external magnetic field, or by a presence of obstacles like the presence of a building between the transmitter and the receiving site so that normal reception is not possible, the directivity pattern of the antenna is still directed towards the correct direction by detecting and identifying such a condition and by using a stored algorithm for controlling the directivity pattern of the antenna. The interruption by the external disturbance or by the presence of obstacles can therefore be avoided and good receiving condition is maintained.

In a preferred embodiment of the present invention, for the antenna, a microstrip patch antenna having a plurality of patch elements is used. In this antenna, the physical antenna elements are not rotated mechanically, but the direction and the shape of the directivity pattern thereof can be varied by controlling the phase shift of the received signals fed from the respective patch elements. The different combinations of the phase shift of the plural patch antenna array and of the behavior of the resultant directivity pattern may be previously stored in the ROM or RAM and a micro-processor is used to select one of the combinations. Other than the microstrip patch antenna, a helical antenna can be used as antenna type, for instance.

The switching of the directivity patterns may be executed at a level higher than the required minimum signal receiving level of the antenna in order to avoid an interruption of the communication link.

When the mobile subject is moving in a very wide area like an open field or over an ocean, the direction of the incoming electric wave towards the antenna may vary depending upon the location of a particular area. Accordingly, an a priori area code or other location information sent to a microprocessor can be used to look up a stored directivity pattern in the ROM. By arranging such a system, the directivity of the antenna may be better matched with the incoming direction of the electric signal.

It is also possible to combine a plurality of microstrip antennas having respective directivity and the output signals are combined to form a composite signal to apply it to the input of the tuner. By forming such a structure a higher system gain or larger signal to the input of the tuber can be expected.

### BRIEF DESCRIPTION OF THE DRAWINGS

FIG. 1 is one embodiment of the receiving apparatus according to the present invention shown in block diagram;

FIG. 2A shows construction of an antenna array of one embodiment of the present invention in plan view;

FIG. 2B is a side view of FIG. 2A;

FIG. 3A shows a list of combination of feeding phase for the antenna elements causing directivity patterns A to E;

FIG. 3B shows a diagram of horizontal and vertical patterns respectively of the directivity pattern A;

FIG. 3C shows a diagram of horizontal and vertical patterns respectively of the directivity pattern B;

FIG. 3D shows a diagram of horizontal and vertical patterns respectively of the directivity pattern C;

FIG. 3E shows a diagram of horizontal and vertical patterns respectively of the directivity pattern D;

FIG. 3F shows a diagram of the horizontal pattern of the directivity pattern E;

FIG. 3G is a diagram showing the relation between the directivity patterns A to D and the shift angle φa of the embodiment of the present invention;

FIG. 4A shows diagrammatically the construction of the geomagnetism sensor used in the embodiment of the present invention;

FIG. 4B shows a diagram representing X axis and Y axis outputs of the geomagnetism sensor;

FIG. 5A shows one embodiment of the receiving apparatus mounted on a vehicle;

FIG. 5B shows various directivity patterns to be controlled to meet the direction of the vehicle;

FIG. 6 is a table showing relation between the reference orientation of the antenna array and the direction of the satellite in horizontal plane;

FIG. 7A is a horizontal stabilizing mechanism for mounting the geomagnetism sensor in plane view;

FIG. 7B is cross-sectional view along line II-II of FIG. 7A; and

FIG. 8 is a flow chart showing the operation of switching the antenna.

### DETAILED EXPLANATION OF EMBODIMENTS

Genera Construction

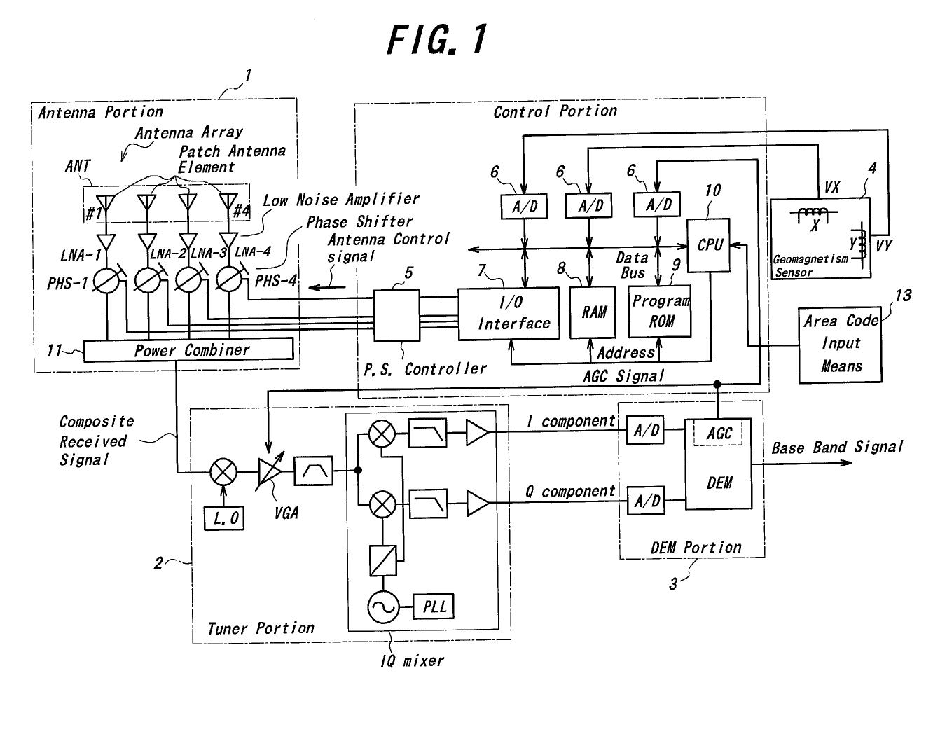

FIG. 1 shows a block diagram of one embodiment of the signal receiving apparatus made in accordance with the present invention. The receiving device of this embodiment is a device for receiving a base band signal modulated by QPSK or BPSK modulation system. Although the device will be explained here as to receive a signal of QPSK or BPSK modulation, but the invention is not limited to such a modulation system. The base band signal is a digital signal obtained by coding an analog signal such as a music and having a transmission error check function. The frequency of the carrier wave is in the S-band, for instance, 2.6 GHz. The antenna array ANT in the antenna portion 1 comprises 4 patch antenna elements #1-#4 each consisting of a microstrip patch antenna. The signal received by respective patch antenna element is amplified by respective one of low noise amplifiers LNA1-LNA4 and than passing through respective one of phase shifters PHS1-PHS4 and then combined in a power combiner 11 and obtained as a composite receiving signal at its output. In this case, by adjusting phases of the phase shifters PHS1-PHS4, the directivity characteristic of the antenna array is determined.

A tuner portion 2 fed with said composite receiving signal has a function to convert the receiving signal into an intermediate frequency band signal and to amplify it in a variable gain amplifier VGA and to produce output signals having both the I component and Q component. In the tuner portion 2, the composite receiving signal converted into the intermediate frequency band and amplified is applied to an input of an IQ mixer. This IQ mixer is known per se so that a detailed explanation is omitted. But it controls the composite receiving signal to be converted into an intermediate frequency band and amplified to derive the I component signal and the Q component signal at output terminals thereof respectively. The two signals of I component and Q component appearing at the two outputs of the tuner portion 2 are applied to inputs of demodulation part 3 and are respectively processed in A/D converter to be a digital signal and derived at the output thereof as a digital base band signal. The demodulator DEM of the demodulation portion 3 outputs an AGC signal as well as a supervising signal of the output level. This AGC signal is partly fed back to the variable gain amplifier VGA of the tuner portion 2. The variable gain amplifier VGA is controlled its gain by the AGC signal so that the IQ mixer is always fed with signal of stable level at the input. The AGC signal is further supplied to an A/D converter 6 in a control portion and converted into a digital signal, which is fed to an input of CPU 10 via I/O interface 7 and is used for controlling the antenna elements.

In the antenna array ANT of this embodiment, the receiving signals from the 4 patch antenna elements #1-#4 are amplified in the low noise amplifiers LNA1-LNA4, respectively and after passing the respective phase shifters PHS1 -PHS4, derived from the output of the power combiner 11 to form a composite received signal. Each of the receiving signals obtained from the patch antenna elements #1-#4 is given a phase shift of 0° or 180° in the respective one of the phase shifters PHS1-PHS4. By the given phase shift in the respective one of the phase shifters, the directivity pattern of the antenna array ANT is decided. Such a controlling technique of the directivity pattern had been disclosed by Tsuji, Matsuzawa, Ito, et al in “Beam Switching Characteristics of a Circular Polarized Wave for Satellite Communication for Mobile Subject” on Electronic Communication Society/TECHNICAL REPORT OFFICE A-P97-81 (1997-08). In the above case, a control signal for giving the phase of the phase shifters or to control it is based on the outputs (VX, VY) of a geomagnetism sensor 4. Namely by a direction indicated by the geomagnetism sensor 4, the directivity of the antenna array 4 is controlled.

The geomagnetism sensor 4, delivers voltage signal components (VX) and (VY) representing geomagnetism components X and Y respectively being an indication of the East-West and North-South direction of the location on a horizontal plane relative to the physical reference orientation of the sensor 4. The VX signal and VY signal are converted into digital value by A/D converters 6 and input to CPU 10 via data bus DATA. The CPU 10 will calculate and decide the orientation of the geomagnetism sensor 4 in real time by using the VX signal and VY signal and the relative orientation angle φb of the sensor 4 against the reference orientation is obtained. The relative orientation angle between the antenna array ANT and the geomagnetism sensor 4 is mechanically fixed to have a certain relation from the structure of the receiving device so that the reference orientation of the geomagnetism sensor 4 is definitely correlated with the reference orientation of the antenna array ANT. In other words, the CPU 10 will decide the horizontal direction of the satellite φa by a relation between the relative orientation angle φb of the geomagnetism sensor 4 and the reference orientation of the antenna array ANT and by comparing it with a stored data concerning the satellite direction memorized in the ROM 9. The CPU 10 is connected to the ROM 9, RAM 8, I/O interface and the A/D converter via a DATA bus and an address bus. ROM 9 stores a program for controlling the CPU 10 and also a data relating to the satellite direction and a data of control signal for controlling the phase shifters for freely varying the directivity pattern of the antenna array ANT. By this, the CPU 10 can vary the directivity pattern of the antenna array ANT freely based on the output of the geomagnetism sensor 4.

As an auxiliary construction, an area code input device 13 is provided. Which device allows the CPU 10 to be able to select areal feature for the local variation of the terrestrial geomagnetism and to vary the directivity pattern of the antenna array to match the local geomagnetism. Even if the output of the geomagnetism sensor is equal, the directivity pattern of the antenna array ANT of the respective antenna portion may be different by the difference of the setting value of the area code. For instance in the United States, a country having very large geographical area, the area may be sub-divided for instance three sub-areas and in each sub-area, the directivity pattern of the antenna array is adjusted in a most suitable manner against the local terrestrial magnetism. The directivity pattern may be set initially depending upon the country of delivery of the receiving device according to the present invention. Although it is not restricted, this area code input device may be set initially by the initial destination of the area or name of the country or states belonging to which area of the geomagnetism or the data may be based on the postal code or a numeral relating to the local terrestrial electromagnetic field strength. The input data may directly set or the data may be derived from area code input means. The data of directivity pattern of the antenna array may be stored in the program of ROM 9 or in a separate ROM for exclusive use.

For example, as an actual case of a satellite seen from a receiving location in an area where the directivity data of the satellite is previously set is assumed as horizontal direction φr=due south, vertical direction θ=about 45°. In this case, the CPU 10 refers the oriental data φr=in the horizontal direction set according to the particular feature of the area belonging to the location being stored in the ROM 9. By this value φr and the horizontal direction of the satellite φa measured from the reference orientation of the antenna array ANT determined by the signal sent from the geomagnetism sensor 4, a signal for determining the best directivity pattern of the antenna array ANT for the most suitable receiving at the time is produced. This signal is sent via I/O interface 7 and phase shifter driver 5 to the phase shifters PHS-1 to PHS-4. For instance, the phase shifters PHS-1 to PHS-3 are controlled as 0° phase shift and the phase shifter PHS-4 is controlled to be 180° phase shift. By this combination of the phase shift to the phase shifters, the directivity pattern of the antenna array ANT is determined. Wherein the RAM 8 has a function to store the data produced from the CPU 10 temporarily.

As has been mentioned above, the directivity of the antenna array ANT is decided by the orientation output of the geomagnetism sensor 4. The strength of the receiving signal received by the antenna array ANT can be evaluated by an AGC signal. This AGC signal is digitalized by the A/D converter 6 and fed to the input of the CPU 10 via I/O interface 7. Thus the CPU 10 can decide on the suitable degree of the directivity of the antenna array ANT. If it is found inappropriate by referring to the AGC signal, the CPU 10 will supply a correction output for correcting the directivity decided by the orientation output sent from the geomagnetism sensor 4 to the phase shifters PHS-1 to PHS-4.

Construction of the antenna array and the directivity pattern

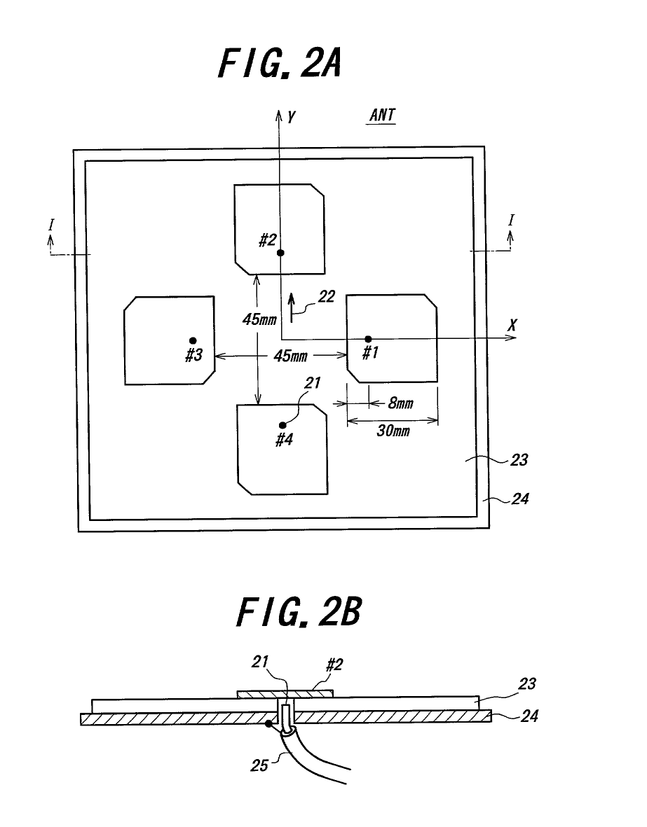

FIGS. 2A and 2B show a practical structure of a single feed circularly polarized wave patch antenna as one example of the antenna array ANT shown in the antenna portion 1 in the FIG. 1 in plan view (FIG. 2A) and I-I cross-section taken along line I-I (FIG. 2B) respectively. In this embodiment, the specification of the antenna is planned that the gain is more than 2.5 dBi at the wave receiving time from the satellite and more than 0.0 dBi at the wave receiving time from the ground gap-filler station (ground retransmission device). In this embodiment, the direction of the satellite is assumed as 45° azimuth angle and as due south in the horizontal plane. A dielectric substrate 23 of (thickness=15.7 mm; εr=3.28; tan δ=0.0025) is used and on one surface thereof patch antenna elements #1-#4 are arranged in counter clock-wise order and rotating symmetrical manner by metal film or foil. Each of the patches is a square form of 30.3 mm×30.3 mm and two corners are cut by 3.4 mm depth. The interval between the two patches arranged oppositely is 45 mm. On the other surface of the substrate 23, a metal ground plate is arranged. Each of the core wires of a coaxial cable 25 is connected to a feed point 21 of the respective patch antenna elements #1-#4 and the outer conductor of the coaxial cable 25 is connected to the ground plate. The receiving signal is fed to the low noise amplifies LNA1-LNA4 shown in FIG. 1 via the coaxial cable 25.

In this embodiment the geographical reference orientation of the antenna array ANT is shown by an arrow mark 22 which is extending from the center point of the antenna array ANT towards the patch antenna element #2. This reference orientation may be any direction being decided geometrically depending on the construction of the antenna array ANT. This reference orientation is a base for deciding the directivity in the horizontal plane where the antenna array ANT is located. The size of the patch antenna is decided by the frequency of carrier wave of the receiving signal. In the embodiment, the patch antenna used is for the case of 2.6 GHz.

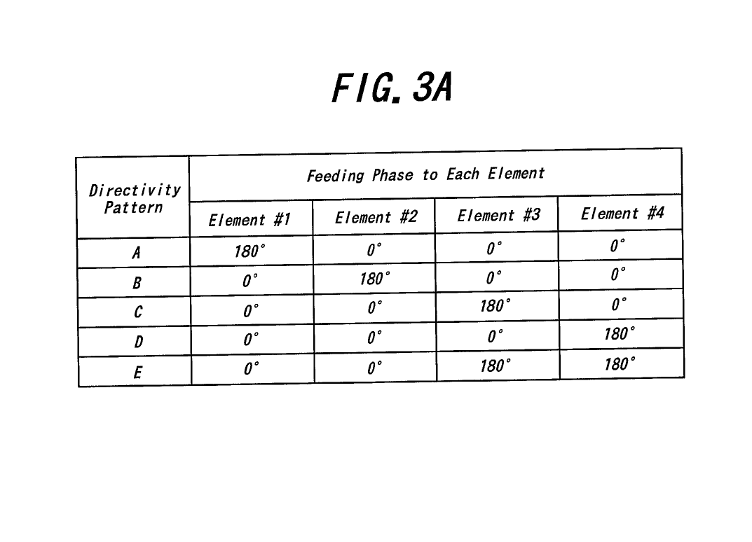

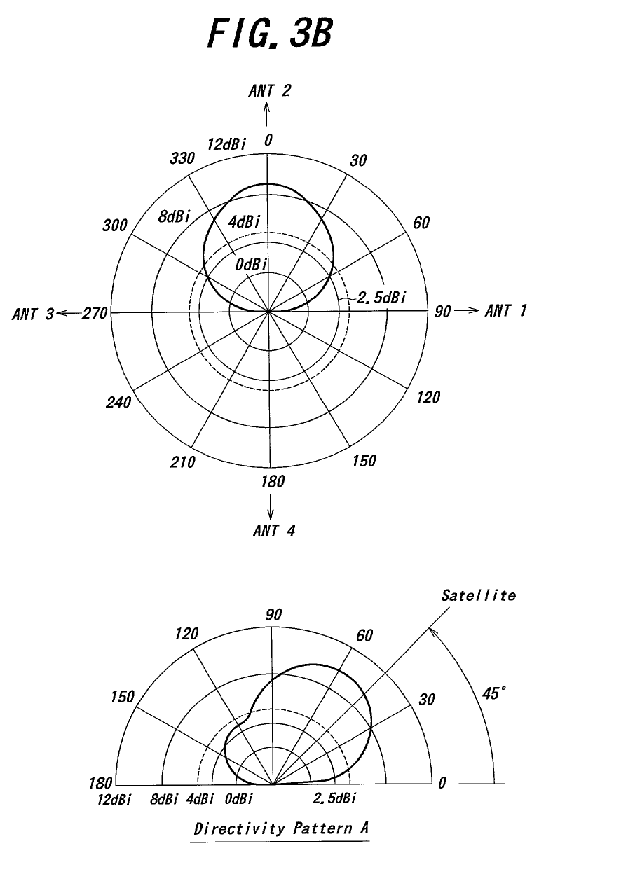

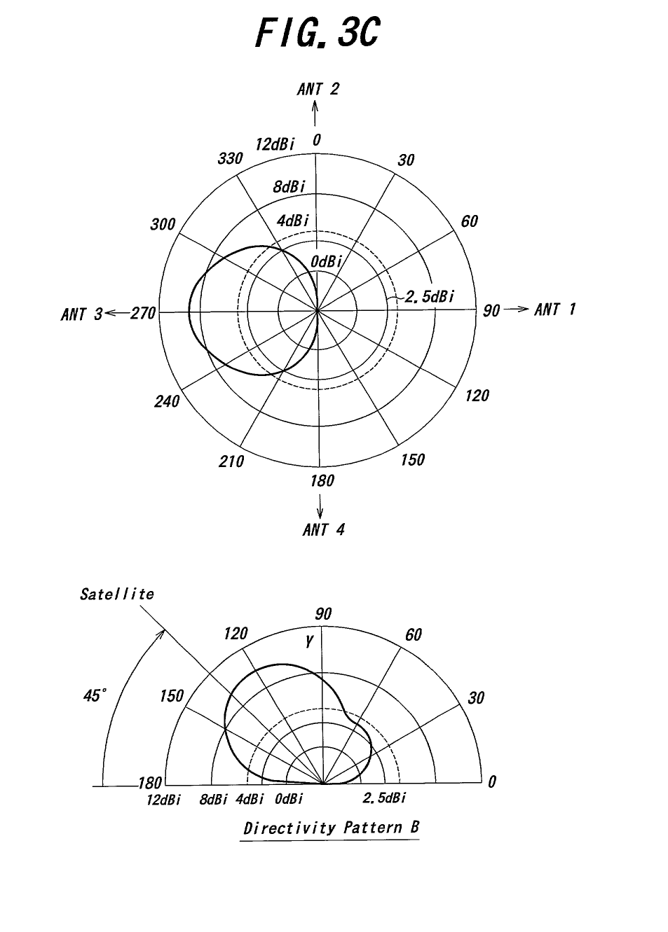

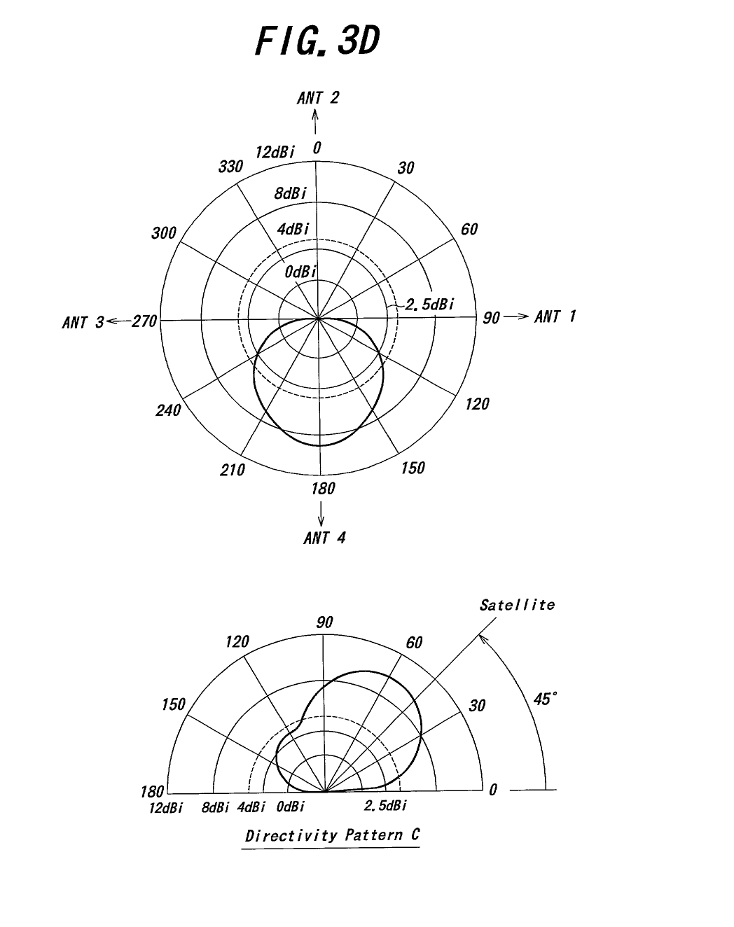

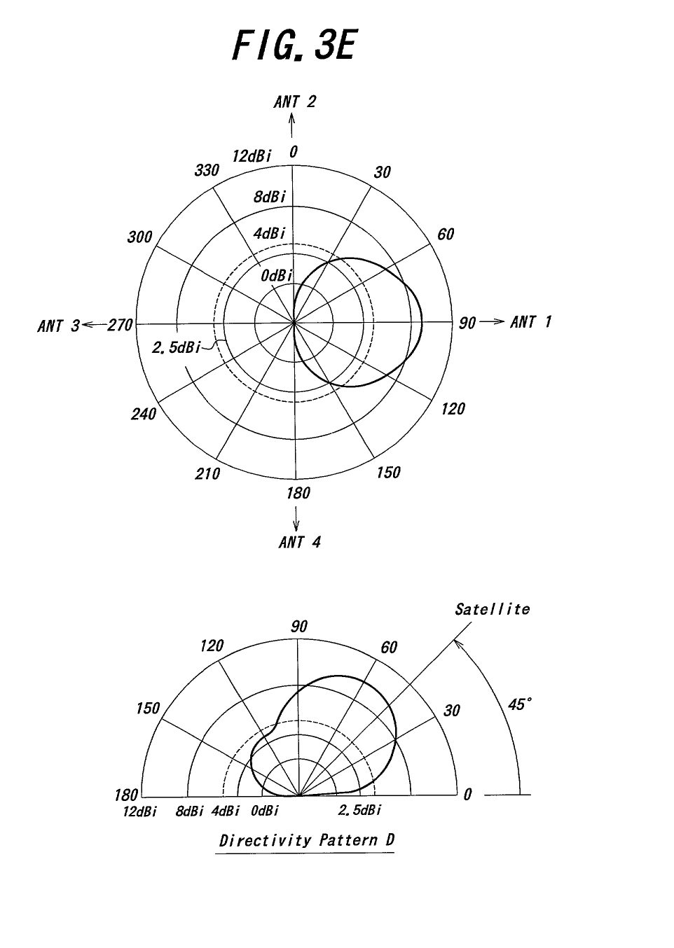

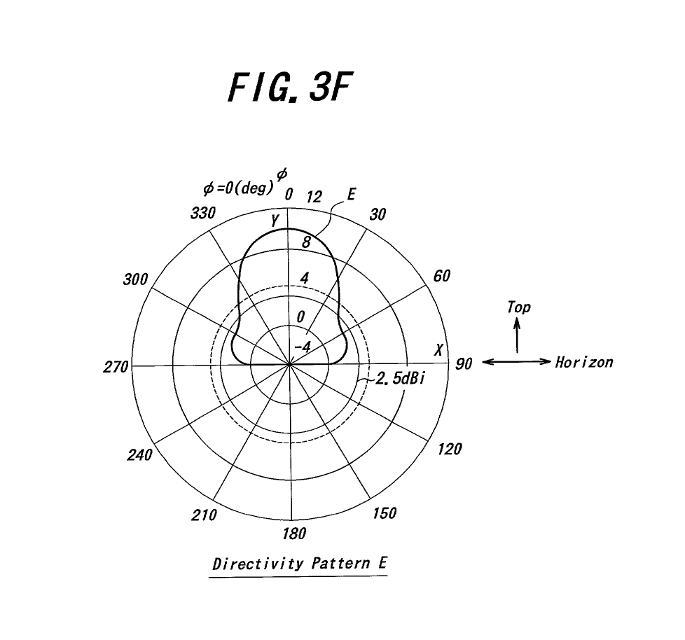

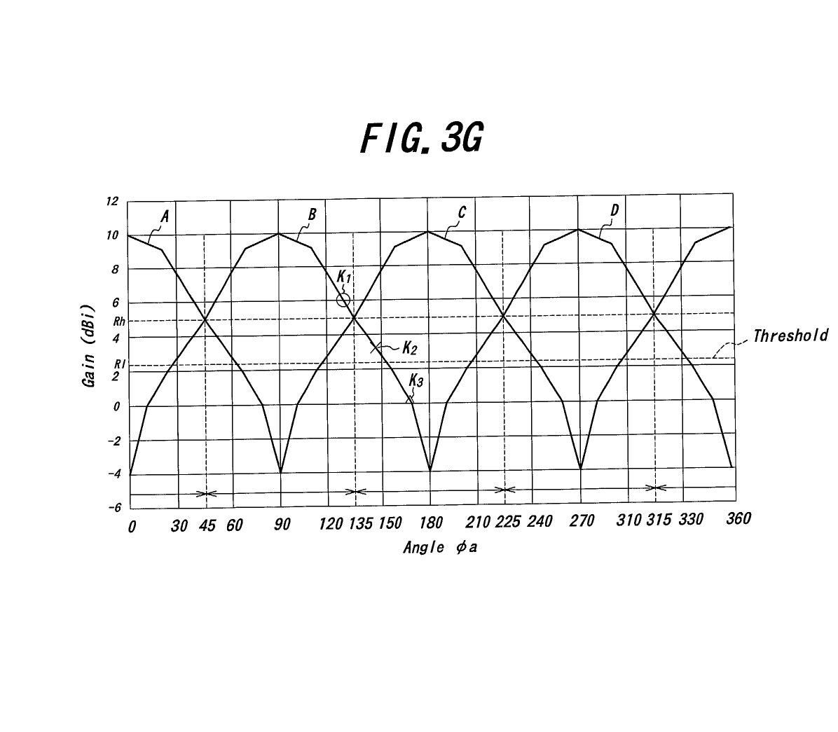

The directivity patterns of the microstrip patch antenna having 4 patch antenna elements #1 -#4 shown in FIGS. 2A and 2B at 2.6 GHz, namely that of the directivity pattern A to D corresponding to 0°, 90°, 180° and 270° controlled by the switching of the beam direction and that E of no directivity, which will be explained by referring to FIG. 3A to FIG. 3F. The switching of the directivity patterns is effected by the control of the phase shifter PHS-1 to PHS-4 shown in FIG. 1 and the matching or not is evaluated by the supplied power combiner signal.

The directivity pattern of the antenna array ANT may be varied by shifting the respective phase of the feeding voltage applied to the four patch antenna elements #1-#4 by the phase shifters. By arranging to shift the phase by 180° for one of the four patch antenna elements and to make phase shift as 0° for other three elements (called as one element counter phase feeding), the directivity pattern becomes to have a peak in one particular direction. The directivity pattern, A-D shown in the Table of FIG. 3A show the possible combination of feeding of the four antenna elements of the antenna awray ANT to have such one element counter phase feeding. FIGS. 3B to 3E show the directivity patterns for each of the above combinations A-D.

These figures show the directivity pattern in the horizontal plane in the upper portion of each figure and in the vertical plane rotated at an azimuth angle of 45° towards the satellite is shown at bottom portion in each figure. In each of the figures showing the directivity pattern in the horizontal plane, the direction shown in the arrow 22 is the reference orientation and assumed as 0°. As shown in these figures, the one element reverse phase feeding produces a directivity pattern having the beam peak in a particular direction of 0°, 90°, 180°, 270° taken from the reference orientation shown by the arrow 22. In this embodiment, the receiving device is one for use in an S-band mobile multimedia satellite broadcasting. In order to receive a satellite transmission, a 2.5 dBi antenna gain is required. To satisfy this antenna gain requirement, the most suitable directivity pattern to the desired direction of the satellite can be obtained by the selection of one of the antenna elements reversing the received phase.

Also for the directivity pattern in the vertical plane, as the receiving gain is more than 2.5 dBi in the azimuth angle from 2-3° to 90°, so that about the azimuth angle of 45° of the direction of a satellite a sufficient gain is assured in wide range. Even the receiving apparatus or the antenna is located in a inclined position, for instance located on a slope a sufficient gain is assured.

In the table of FIG. 3A, the pattern E is an example in which two adjacent elements, for instance #3 and #4 are arranged to be fed 180° phase shift and rest two elements are arranged as 0° phase shift (adjacent two elements reverse phase feeding). The directivity pattern in vertical plane is shown in FIG. 3F. As can be seen therefrom, beam peak appears at azimuth angle 90° and for such large azimuth angle portion almost no directivity is seen in the horizontal plane.

The required antenna receiving gain is 0 dBi for receiving radio wave from a gap-filler (ground retransmission station) provided to cover an area not able to receive the direct wave from the satellite in the S-band mobile multi-media satellite broadcasting system. In the case of two elements reverse feeding as shown in FIG. 3F, it is possible to receive the wave from the gap-filler which may locate any direction seen from the antenna array ANT.

FIG. 3G shows a relation between the receiving gain dBi of (directivity A, B, C, D) based on a directivity pattern having the beam peak in different directions (0°, 90°, 180°, 270°) in the horizontal plane in a case of one element reverse feeding and the horizontal direction of satellite against the arrow mark 22 being the reference orientation of the antenna array ANT. As an example, if the reference orientation of the antenna array ANT shown by the arrow mark 22 is directed towards due south, the horizontal direction angel φa of the satellite with respect to the reference orientation i.e. the direction of arrow 22 becomes as (φa=0° and thus the directivity pattern A is selected and the receiving gain becomes 10 dBi. If the antenna is moved and it becomes φa=45°, then the receiving gain at the pattern A becomes 5 dBi and the pattern crosses that of pattern B. If the antenna further moves and rotates and it becomes φa>45° by switching the feeding of the antenna elements to assume pattern B, the receiving gain can be held at high value. Thus in a usual case, by switching the directivity pattern as A→B→C→D→A, at φa=45°, 135°, 225°, 315°, the receiving gain can be kept always at the high value.

The receiving apparatus for the S-band mobile multi-media satellite broadcasting is requested to have the receiving gain of 2.5 dBi. However, by arranging the switching point of the directivity pattern is set at least 2.5 dBi as in the case of the above embodiment, an interruption of receiving may not occur.

As has been explained hereinbefore, in the receiving apparatus according to the present invention, the directivity pattern is controlled so that the receiving gain for the wave from a satellite will not become lower than the requested value. If such receiving gain is not obtainable even by the control of the directivity patterns, a judgement is made that the area is that the wave from the satellite is not arriving and the directivity pattern is switched to the non-directivity one to be able to receive a wave from a gap filler of which location is indefinite. When a receiving gain for the wave from such a gap-filler is also unobtainable, then further switching is effected to try to receive the wave from the satellite.

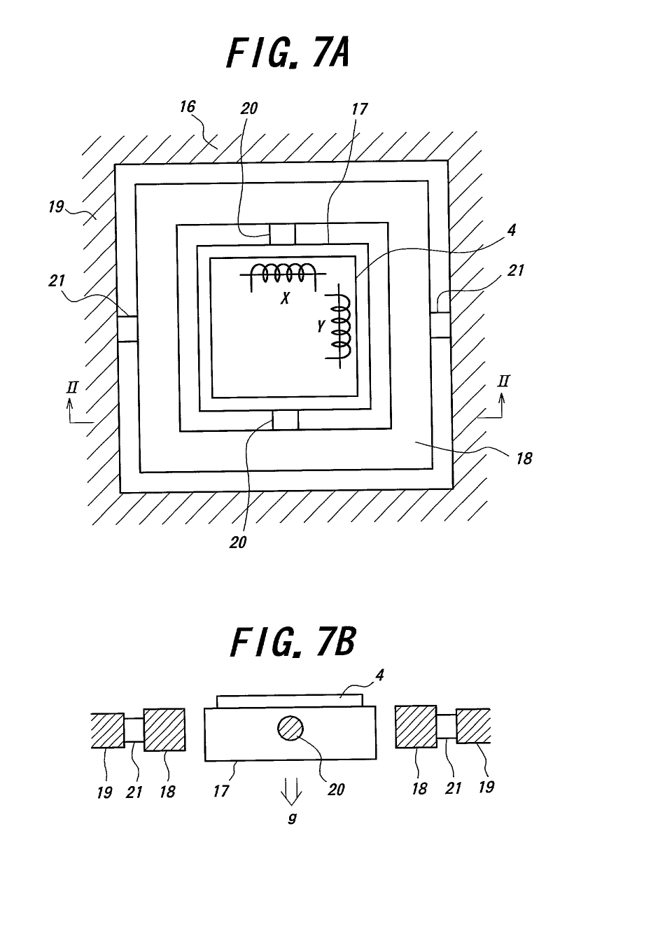

If it is arranged to be able to input an area code, by using such area code to vary the directivity against the geomagnetism becomes possible. A table shown in FIG. 7 shows the horizontal direction of the satellite against the reference orientation of the antenna array ANT. In which, the area A corresponds to the aforementioned explanation. By using the output from the geomagnetism sensor 4, directivity pattern A is assumed when the horizontal direction φa of the satellite against the reference orientation of the antenna is in between 0-45° and 316°-360°, directivity pattern B is assumed when it is 46°-135°, pattern C is assumed when it is 136°-225°, and pattern D is assumed when it is 226°-315°. When the area B or C is selected, by the output of the geomagnetism sensor 4 a corresponding directivity pattern is selected when the horizontal direction φa of the satellite against the reference orientation of the antenna is varied. As for actual example, the area A may be Tokyo, the area B and C may be Seoul and periphery and Beijing and periphery, respectively. In this example, the number of the areas is 3 and the interval between adjacent areas is assumed as 15°. However, the number of areas may not be limited and a more larger number may be applied.

As mentioned above the signal received in the respective patch antenna is amplified in the low noise amplifiers LNA1-LNA4 and after passing the phase shifters PHS1-PHS4 and combined in the power combiner 11 and output as a resultant composite signal. The phase shifters PHS1-PHS4 are controlled by the phase shifter driver 5.

In the above example, four patch antenna elements are used for the antenna array ANT in the antenna portion 1. It is also possible to use a helical antenna in place of the patch antenna elements. Further a more number of antenna elements than four elements may be used. When using the helical antenna element, the gain may be increased by 3 to 4 dBi.

Geomagnetism Sensor

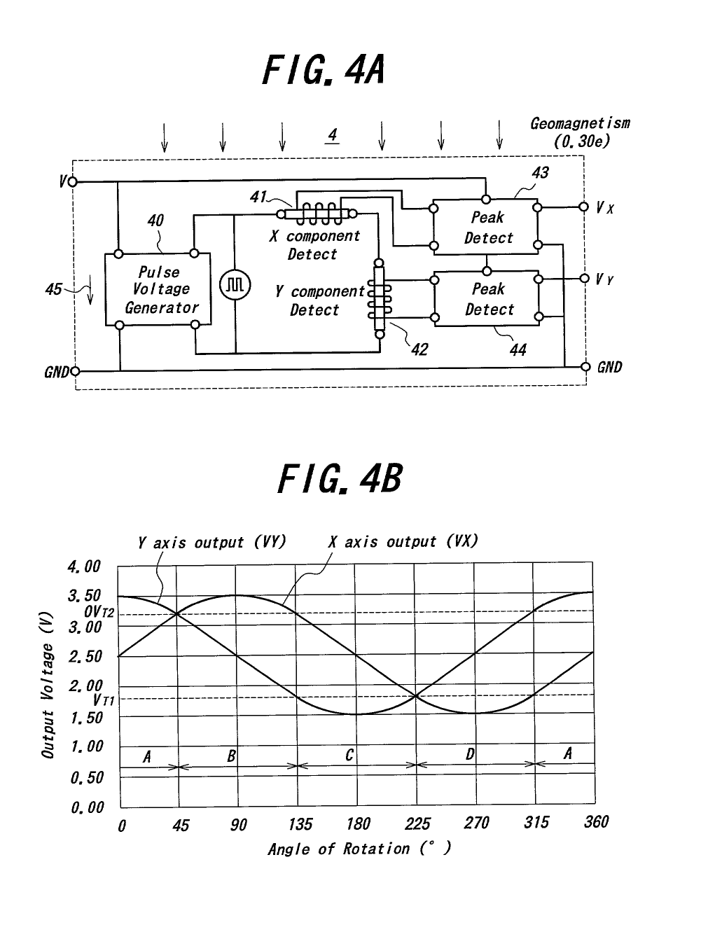

FIG. 4A shows an example of construction of the geomagnetism sensor 4 shown in FIG. 1. This sensor is a quadrant flux gate type mini-size geomagnetism sensor made by TDK Corp. (Registered Trademark: TMS-215/TMS-115). The outer size of the geomagnetism sensor is, for example, 3.2 cm×2.3 cm and being compact type. FIG. 4B shows output voltage characteristics when it is rotated in a magnetic field of 0.30e being approximately same as the geomagnetism in Tokyo area of Japan.

In the X axis component detecting element 41 and Y axis component detecting element 42 on which a detecting coil is wound, a strip shaped conductor is provided along the core threrof and a pulse current produced by a pulse voltage generating circuit 40 is applied to the strip shaped conductor. During a very short time at which the conducting current is reached to a peak value, the core becomes fully saturated and the permeability of the core material is varied. The magnetic flux of the geomagnetism having its component parallel to the core is not passing through the core during the saturation period of the core. But the flux will pass through the core in the non-saturation period. So that the magnetic flux of geomagnetism varies alternatively. The variating geomagnetic flux in the core can be detected for the parallel component of the geomagnetism by peak detecting circuit 43 and 44 at the time of the peak of the exciting current by output VX and VY of the detecting coils.

Referring to FIG. 4A, assuming that the geomagnetism is parallel to the Y axis component detecting element 42 and that the reference orientation 45 is 0° rotation angle, the relation of X axis output VX and Y axis output VY against the rotation angle is shown in FIG. 4B. VX and VY are output as 2.50V±1.0V. This means that when the reference orientation of the geomagnetism sensor 4 is directed towards due south VX=2.50V and VY=3.50V.

Since it is preferred that the geomagnetism sensor is so arranged that both the X axis component detecting element 41 and the Y axis component detecting element 42 are kept in normal direction against the direction of the gravity, the geomagnetism sensor may be constructed to be mounted on horizontal stabilizing means 16. FIGS. 7A and 7B show the horizontal stabilizing mechanism 16 mounting geomagnetism sensor 4 in front view in FIG. 7A and a cross-sectional view taken along one dot chain line II-II in FIG. 7B.

The geomagnetism sensor 4 is mounted on geomagnetism sensor supporting means 17 having its center of gravity along the direction of the gravity. This supporting means 17 is rotatably supported via X direction rotating means on an intermediate supporting means 18. Said intermediate supporting means 18 is in turn supported by the supporting means 19 via Y direction rotating means 21 having the center of rotation normal to that of X direction rotating means. The supporting means 19 is fixed for instance on bottom surface of a vehicle on a substantially the same plane of mounting the geomagnetism sensor 4. By this way, even the vehicles or the like mounting the geomagnetism sensor 4 is inclined at a slopy road, the geomagnetism sensor 4 can correctly detect the geomagnetism.

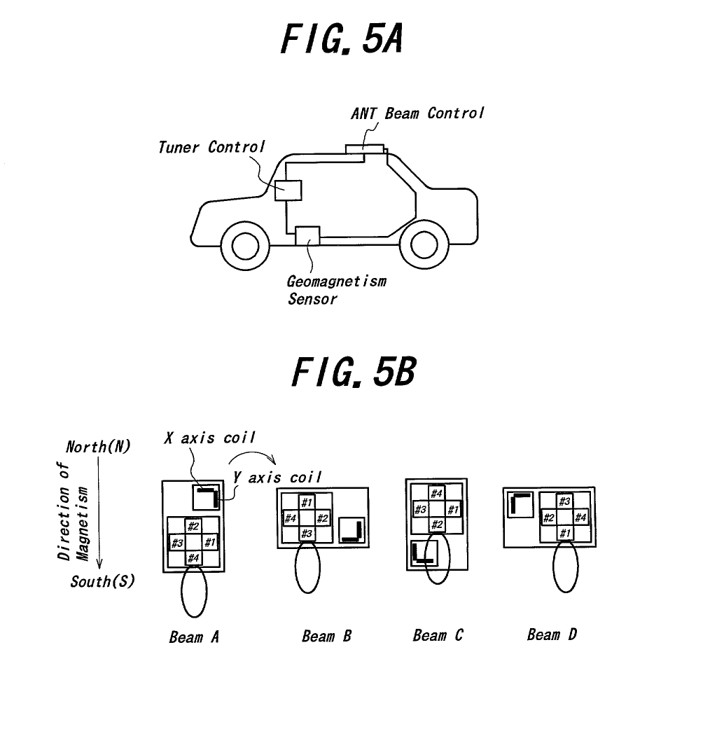

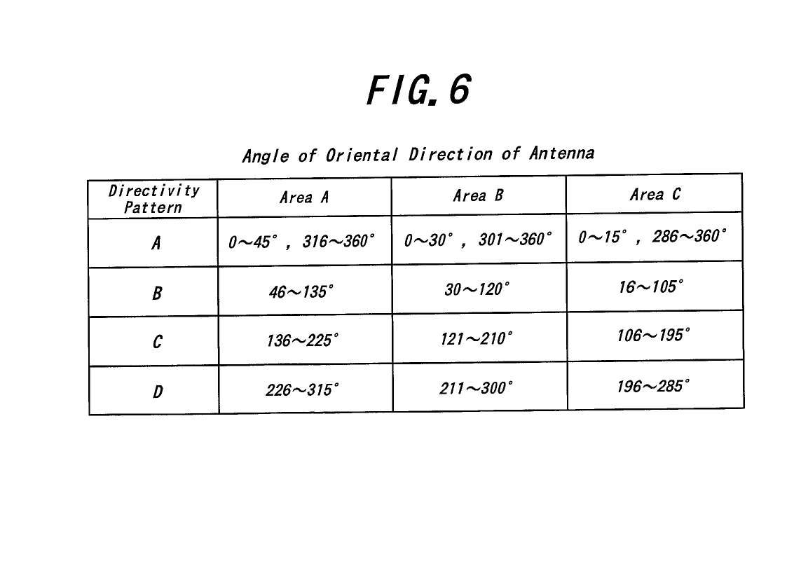

FIGS. 5A and 5B show a practical embodiment for the mount of the receiving device according to the present invention on a vehicle and its antenna location to be controlled the directivity characteristics according to the turning of the direction of the vehicle. The antenna array ANT mounted on the roof of the vehicle and the geomagnetism sensor 4 are so fixed that the reference orientations 22 and 45 are matched with a predetermined relation. The demodulator portion, tuner portion, controlling portion or the CPU controlling all these equipments and the like are preferred to be mounted inside the vehicle. The signal received by the antenna is introduced in inside of the vehicle and received and demodulated at tuner/demodulator portion. The direction of the beam of the directivity pattern of the antenna controlled according to the present invention is always directed towards exact south or the neighborhood by switching the directivity pattern despite the direction of the vehicle. The geomagnetism sensor may be mounted underneath the bottom surface of the vehicle and many modification may be possible for the mount of various element of the device.

Control Flow

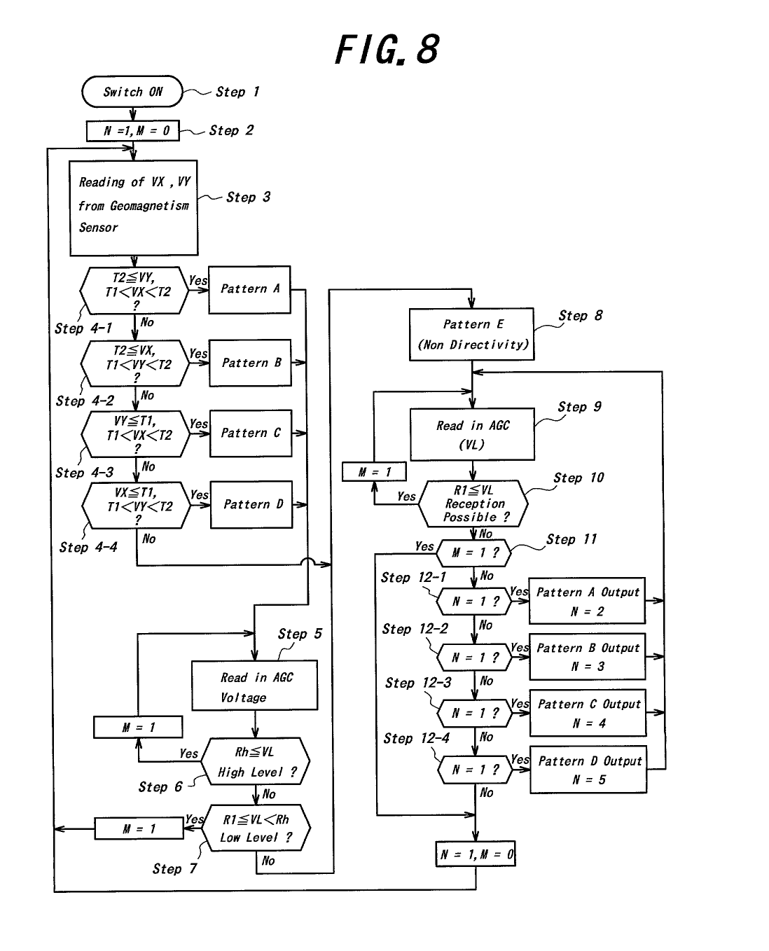

FIG. 8 shows a flow chart for the control of switching the directivity pattern of the antenna in the array ANT. The following is a brief explanation of the control flow.

Step 1: The device becomes power-on to reset the system for the prosecution of the control flow.

Step 2: Initialization of the processor consisting of the CPU, register (m), etc and write-in the register m=0.

Step 3: The CPU read-in the output signals VX and VY from the geomagnetism sensor after applying A/D conversion. In this step, a threshold values (VT1, VT2) for switching the directivity pattern of the antenna is set. The directivity pattern of the antenna is normally as shown in FIG. 4B, having the A to D patterns, wherein pattern A is for φa=315°-45°, B pattern is φa=45°-135°, C pattern is φa=135°-225° and D pattern is for φa =225°-315° and these patterns are to be selected and switched.

Steps 4-1 to 4-4; by a comparison between the output signals (VX, VY) and the threshold values (VT1, VT2) a judgement is made for the incoming direction of the receiving signal a control signal to obtain a most suitable directivity pattern is output by the phase shifters.

The value of the output signal of the geomagnetism sensor is defined under a predetermined condition that the sensor is located horizontally. By this consideration, it is preferred to use the aforementioned horizontal position keeping means for the geomagnetism sensor. If such means are not provided, tilting of the sensor will result to make the peak value of the output signal lower. However, even under such circumstances, it is possible to keep the receiving gain in the required gain range by adjusting the threshold value against the output signals (VX, VY) of the geomagnetism sensor in order to switch the directivity pattern in time. As can be seen from the diagram of FIG. 4B, for instance, usually the threshold value VT1 is 1.8V and the threshold value VT2 is 3.1V. But if the value VT1 is changed to 1.9V and the value VT2 is changed to 3.1V, it becomes to possible to respond smaller value of peak of the sensor signal output. However, the switching direction will become different from the normal exact angle of φa=45°, 135°, 225°, 315°. In such case, by considering the width of the directivity of the antenna, the required value can be satisfied. It is also possible to obtain a best receiving condition by selecting the threshold values depending upon the condition of the broadcasting and the environment of location of the receiving device.

When the directivity pattern of the antenna is selected either one of A-D, the system goes to step 5. In this step 5, the AGC signal (VL) output from the demodulator as a supervising signal is read-in. In step 6, said AGC signal (VL) is compared with a threshold value (Rh) for switching. This threshold value (Rh) means a signal corresponding to the receiving gain of a selected directivity pattern at the time of φa=45°, 135°, 225° and 315°. Where if the AGC signal (VL) is larger than the threshold value (Rh) the process goes again to the step 5 and m=1 is written in the register. Namely, if the AGC signal (VL) is larger than the threshold value (Rh), the directivity selected then is maintained.

When by some reason, if the AGC signal (VL) can not exceed the threshold value (Rh), process goes to step 7. In the step 7, the AGC signal (VL) can not exceed the threshold value (Rh), but if the receiving gain is higher than that required for the antenna for receiving S-band mobile multi-media satellite broadcasting signal, it is assumed that the receiving gain had decreased by the moving of the receiving location of the receiving device and the process moves to step 3 and the suitable directivity is selected again in the step 4.

However, if AGC signal (VL) can not exceed the threshold value (Rh) and also the receiving gain is smaller than the receiving gain R1 required for the S-band mobile multi-media satellite broadcasting, a judgement is made that the area is unable to receive the wave from the satellite and moves to step 8 and to change to horizontal plane non-directivity E in order to receive a wave from the gap-filler station. For obtaining the horizontal plane non-directivity, the phase shifter is so controlled that to realize two adjacent elements reverse feeding.

Then moves to step 9, and the AGC signal (VL) is read-in again and in order to receive the wave from a gap-filler, this value is compared with the required value (R1) for the antenna in step 10. If the AGC signal (VL) is larger, moves to step 9 again to maintain the pattern E. Again M=1 is written in the register.

Here, if the AGC signal (VL) becomes smaller than the value (R1) corresponding to the required receiving gain for the antenna for receiving the electromagnetic wave from the gap-filler, then moves to step 11 to check the condition of the register and if m=1 again moves to step 3 to search whether or not the receiving is possible by the directivity at that time.

In the situation that both the satellite signal can not be received and even switching to receive the wave from the gap-filler no reception is possible. In this case, when checking the condition of the register in step 11, and then m=0. In this case not moving to step 3 but moves to step 12-1 to 12-4. At this step, a successive scanning from receiving pattern A to receiving pattern D and the receiving condition is checked in steps 9 and 10, respectively. At this step if the wave from the gap-filler satisfies the condition, the receiving gain in any of the directivity patterns, the condition is maintained.

The receiving pattern with directivity has the peak of reception sensitivity in a particular direction. So that there is a possibility to be able to receive the wave from a remote gap-filler rather than the usual receiving pattern for receiving the wave from a gap filler near by which is a non-directivity in the horizontal plane. This process is just an auxiliary one and it is used both when the selection is made for a receiving pattern using the geomagnetism sensor to receive wave from the satellite or when switched to receive the wave from a gap-filler. Both cases are only the ones that the wave is unreceivable.

If the aforementioned area code input means are used, it is possible to directly read out the most recently set area code in step 2. If the code has not been set, it may be possible to ask the user to input the area code.

Effect of the Invention

In accordance with the present invention, the directivity of the antenna is switched by detecting the direction by the geomagnetism sensor and the receiving signal level by AGC so that even if the receiving device rotates its direction, a same receiving condition is maintained without interruption.

Under a condition that the wave from satellite is unreceivable, by switching the directivity suitable for the reception of the electromagnetic wave sent from a ground retransmission station, the interruption can be kept minimum. A switching in the reverse direction is also possible.

Even if the geomagnetism sensor is not able to detect a correct direction by an outer disturbance such as an architectural magnetic field, it is possible to scan and find an available directivity pattern of the antenna to minimize the interruption of receiving.

By giving directivity for the antenna towards the transmitting station, the gain will have a more tolerance and the receiving limit against the attenuation of the electromagnetic wave by the weather like rain or snow can be made higher.

What is claimed is:

1. Receiving apparatus for receiving satellite broadcasting electric wave at least comprising an antenna able to have a plurality of different directivities of the antenna, a tuner being fed with receiving signal of the antenna, a processor for controlling the antenna and for producing an antenna control signal for deciding one directivity pattern among the plurality of directivity patterns and a geomagnetism sensor,
wherein said geomagnetism sensor produces a direction signal indicating a predetermined physical reference orientation of the antenna, and
said processor generates said antenna control signal based on said direction signal.

2. Receiving apparatus as claimed in claim 1, wherein said antenna comprises of a plurality of conductive elements such as a micro-strip patch antenna array arranged in one plane.

3. Receiving apparatus as claimed in claim 1, wherein said antenna comprises of a plurality of conductive elements such as helical antenna array.

4. Receiving apparatus as claimed in claim 2, wherein the receiving electric wave signal derived from each of said plurality of conductive elements is combined after passing each of respective phase shifters to form a composite wave signal for the tuner for deciding the directivity of the antenna, and said phase shifters are controlled by said antenna control signal produced from said processor.

5. Receiving apparatus as claimed in claim 3, wherein the receiving electric wave signal derived from each of said plurality of conductive elements is combined after passing each of respective phase shifters to form a composite wave signal for the tuner for deciding the directivity of the antenna, and said phase shifters are controlled by said antenna control signal produced from said processor.

6. Receiving apparatus as claimed in claim 4, wherein said phase shifters are so formed that to apply at least 180° and 0° phase shift for the respective receiving electric wave signal fed from each of the plurality of patch elements.

7. Receiving apparatus as claimed in claim 5, wherein said phase shifters are so formed that to apply at least 180° and 0° phase shift for the respective receiving electric wave signal fed from each of the plurality of patch elements.

8. Receiving apparatus as claimed in claim 1, wherein the geomagnetism sensor produces two detection signals from two detection axes normal to each other as the direction signals on the horizontal plane and outputs the detection signals.

9. Receiving apparatus as claimed in claim 1, wherein said processor comprises a memory for memorizing control signal corresponding to patterns of directivity which the antenna can assume and decides the directivity pattern to be taken by the antenna based on the direction signal fed from the geomagnetism sensor and the processor produces and outputs a control signal to let the antenna to assume the decided directivity pattern.

10. Receiving apparatus as claimed in claim 1, wherein said processor responds to strength of the receiving electric wave and outputs antenna control signal to let the antenna to assume non-directivity pattern.

11. Receiving apparatus for receiving electric wave sent from a ground transmitter station and from a broadcasting satellite, comprising an antenna for receiving at least the electric wave from the ground transmitter station and from the broadcasting satellite, means for detecting present orientation of said antenna, directivity control means for said antenna based on an output signal of said orientation detecting means, and signal receiving means for signal delivered from the antenna,
wherein said antenna is formed of a plurality of antenna elements, and the apparatus comprising phase shift means for shifting phase of feeding current at each feeding point of said antenna elements, and said control means for antenna apply a control signal based on an output of said orientation detecting means to said phase shift means to decide the directivity pattern of the antenna.

12. Receiving apparatus as claimed in claim 11, wherein said orientation detecting means is a geomagnetism sensor.

13. Receiving apparatus as claimed in claim 11, wherein said control means outputs a control signal to let the antenna to assume non-directivity pattern in response to the strength of receiving broadcasting wave.

14. Receiving apparatus as claimed in claim 1, wherein each of the plurality of directivity patterns of which the antenna can assume has peak of gain in a horizontal plane in different direction each other, and the directivity pattern is switched based on a threshold value being a level higher than a minimum receiving gain requested by the antenna.

15. Receiving apparatus as claimed in claim 11, wherein each of the plurality of directivity patterns of which the antenna can assume has peak of gain in a horizontal plane in different direction each other, and the directivity pattern is switched based on a threshold value being a level higher than a minimum receiving gain requested by the antenna.

16. Receiving apparatus as claimed in any of the preceding claims, wherein the geomagnetism sensor is mounted on a horizontal position stabilizing device.

17. Receiving apparatus as claimed in any of the preceding claims, wherein an area code input device is provided to adjust locational error of geomagnetism in a very wide area.
